(19) United States
(12) Patent Application Publication
(10) Pub. No.: US 2009/0082218 A1
(43) Pub. Date: Mar. 26, 2009

(54) 3'-Based sequencing approach for microarray manufacture

(76) Inventors: Paul Harkin, Dromore (IE); Karl Mulligan, Northern Ireland (IE); Austin Tanney, Antrim (IE); Gavin Oliver, Knockmenagh (IE); Ciaran Fulton, Forkhill (IE)

Correspondence Address: KING & SPALDING LLP, 1180 PEACHTREE STREET, ATLANTA, GA, 30309-3521, US

(21) Appl. No.: 12/228,311

(22) Filed: Aug. 12, 2008

Related U.S. Application Data
(60) Provisional application No. 60/964,470, filed on Aug. 13, 2007.

(51) Int. Cl. C40B 30/04; C40B 50/00; C40B 40/06

(52) U.S. Cl. 506/9; 506/23; 506/16

(57) ABSTRACT

Methods are described to derive design sequences for the production of nucleic acid microarrays. The present methods use high throughput 3′ sequencing of transcripts in a tissue sample or diseased state to design probes for nucleic acid microarrays. Also described are nucleic acid microarrays that possess probes directed to the extreme 3′ end of transcripts in a tissue. These microarrays preferably represent alternate polyadenylation sequences that are specific to the tissue from which the transcripts are derived. Also described are methods of using the microarrays directed to the extreme 3′ end of the transcript for evaluating gene expression in a tissue where there are reduced false positive and false negative results.

### CLAIM OF PRIORITY AND CROSS-REFERENCE TO RELATED APPLICATIONS

This application claims priority of U.S. provisional patent application 60/964,470 filed on Aug. 13, 2007 which is incorporated herein by reference.

### FIELD OF THE INVENTION

The present invention is directed to methods for using of 3′ sequencing of nucleotides for designing nucleic acid microarrays. The present invention is also directed to methods of using 3′ sequencing to identify transcriptomes of tissues.

### BACKGROUND

Conventionally used DNA microarrays manufactured by Affymetrix and other microarray companies are generated from publicly available data. While most arrays are designed with a 3′ bias, the sequence data used for probe design is taken from public databases primarily derived by means of 5′ sequencing. These sequences are mostly complete, but do not account for alternative polyadenylation, at 3′ ends of the sequences as they are expressed in different tissue and disease settings.

For example, it has been estimated that more than 29% of human genes have alternative polyadenylation [poly(A)] sites. (Beaudoing, E (2001) Genome Res., 11, 1520-1526). The choice of alternative poly(A) sites is believed to be related to biological conditions such as cell type and disease state (Edwalds-Gilbert, G et al. (1997) Nucleic Acids Res., 25, 2547-2561). When a 3′-terminal exon is alternatively spliced, alternative polyadenylation is involved. Alternative polyadenylation can result in mRNAs with variable 3′ ends, or proteins with different C-termini depending on the tissue or disease state. A growing number of genes have been found to be regulated by this mechanism. Although efforts are being made to create a database of alternate polyadenylation sites, not all such sites are currently known. (Zhang et al. Nucleic Acids Research, 2005, Vol. 33, Database issue D116-D120). Furthermore, when designing tissue-specific or diseases-specific microarrays, a lack of attention to alternate polyadenylation may result in sub-optimal gene expression profiling and false negative and false positive results when ultimately used. Deriving microarrays from public databases does not account for alternative polyadenylation. There is not a great degree of 3′ sequencing and predominantly alternative 3′ polyadenylation is not well represented in public databases.

It has also been reported in the literature that there is often tissue specific polyadenylation, as such this highlights further the importance of establishing the true 3′ end as expressed in the disease or tissue of interest. More than one-third of human pre-mRNAs undergo alternative RNA processing modification, making this a ubiquitous biological process. The protein isoforms produced have distinct and sometimes opposite functions, underscoring the importance of this process. A large number of genes in mammalian species may undergo alternative polyadenylation, which leads to mRNAs with variable 3′ ends. As the 3′ end of mRNAs often contains cis elements important for mRNA stability, mRNA localization and translation, the implications of the regulation of polyadenylation may be multifold. Alternative polyadenylation is controlled by cis elements and trans factors, and is believed to occur in a tissue- or disease-specific manner. Given the availability of many databases devoted to other aspects of mRNA metabolism, such as transcriptional initiation and splicing, systematic information on polyadenylation, including alternative polyadenylation and its regulation, is noticeably lacking.

Therefore, it is important to derive the true 3′ end of the sequence corresponding to specific tissues and diseased states for improved detection with microarrays.

### SUMMARY OF THE INVENTION

Methods are provided herein to produce microarrays using design sequences that are derived from RNA transcripts that are sequenced with 3′ sequencing. These methods permit the generation of tissue-specific and disease-specific microarrays containing probes to alternatively polyadenylated transcript forms otherwise not present on conventional arrays. These methods provide arrays that reduce false positive and false negative results when ultimately used for expression profiling or diagnostic or prognostic methods.

Furthermore, one of ordinary skill in the art will appreciate that there are a number of alternative 3′ polyadenylated transcript forms depending the tissue types and disease states. To address this variability, methods are provided for high throughput 3′ sequencing of transcripts in order to identify the true 3′ end of the transcripts from the tissue or disease under investigation.

In one embodiment, transcripts are sequenced from the extreme 3′ end to derive the specific 3′ end sequence for that tissue or diseases state taking into account alternative polyadenylation sites. The resulting extreme 3′ sequences are then used as design sequences for probe design and array generation.

In another embodiment, transcripts in a sample of isolated RNA sample are subjected to high throughput 3′ sequencing until substantially all transcripts in the RNA sample are sequenced. These extreme 3′ sequences are then used as design sequences for probe design and array generation. The methods described herein result in an extreme 3′ bias to the arrays more so than then standard commercially available arrays. The 3′ bias in probe design for the microarray is directed to the last 300 bases. However, an important distinction is in the generation of the design sequences. In 3′ sequencing, the actual 3′ end of the transcript is derived and the array is designed based on the actual sequence determined to be the real and correct 3′ end of the transcript as expressed in a tissue or disease state of interest.

The advantages of using these methods include identification of tissue-specific or disease-specific 3′ variants; identification of multiple 3′ variants within disease/tissue types and deriving more accurate sequence for use with both fresh frozen and formalin-fixed-paraffin embedded tissue.

It is therefore a goal of the present invention to provide methods for deriving the input sequence set that is used to design probes for a microarray.

It is another goal of the present invention to provide tissue and diseases-specific sequences for probe design.

It is yet another goal of the present invention to increase the accuracy of accuracy and detection of specific transcriptomes by using microarrays designed with tissue and disease-specific probes.

### DETAILED DESCRIPTION OF THE INVENTION

### I. Methods of Producing an Array

The methods provided herein are directed to producing microarrays derived from pools of transcripts sequenced from their 3′ end thereby providing an accurate representation of the polyadenylation sites of the tissue or disease-state from which the tissue is harvested. These methods result in an extreme 3′ bias to microarray design more than the 3′ bias that exists in standard commercially available microarrays. These methods are also valuable for processing patient tissue samples harvested and preserved in different ways and for identifying pools of transcripts for probe design that are specific for a particular tissue type or disease state. This refinement of existing microarray technology permits a more accurate and targeted analysis of patient tissue samples.

As used herein, the “3′ bias” of a microarray means that, in the design of the array, the probes are chosen from the 3′ region of the representative transcript or design sequence. Generally, nucleic acid microarrays are 3′ biased and it is common among major manufacturers of microarrays to use 3′ biased probes. In the case of most Affymetrix expression arrays, for example, the probes are chosen from the last 600 bases.

The term “extreme 3′ end” of a transcript used for probe design as used herein generally refers to about the 300 bp closest to the 3′ of the transcript. Probe design uses the most 3′ part of a sequence measured from the polyadenylation site. In other embodiments, the last 500 bp, 400 bp, 250 bp or the last 200 bp are used as the extreme 3′ end for probe design.

FFPE samples introduce unique challenges for microarray analysis, including potential fragmentation and chemical modification of RNA molecules. Typically, only fresh frozen tissue may be examined because the RNA is better preserved and there is significantly less degradation. This is unfortunate since many FFPE tissue samples may not be examined retrospectively using these microarrays. The use of 3′ biased design negates the problems that occur as a result of 5′-3′ degradation of RNAs (e.g. via 5′-3′ exonuclease activity). The extreme 3′ bias has also been demonstrated to result in significantly increased detection rates and stronger signal in microarray experiments. By designing microarray probes from the extreme 3′ end of the transcript the present methods produce microarrays that permit study of RNA extracted from both FFPE and fresh frozen tissue because probes designed at the extreme 3′ end of the transcript have greater efficiency of transcript detection enabling profiling of partially degraded RNA, such as that extracted from FFPE tissue. Furthermore, as opposed to simply using the extreme 3′ end of known sequences in public databases, the use of 3′ sequencing provides the true extreme 3′ sequence of a tissue-specific or disease-specific transcript for probe design.

As used herein, the term “3′ sequencing”, means sequencing a transcript from the 3′ end where the 3′ end includes the poly(A) tail. Conventional sequencing methods may be used to determine the true sequence of the 3′ end of a transcript.

The term “fragment,” “segment,” or “DNA segment” refers to a portion of a larger DNA polynucleotide or DNA. A polynucleotide, for example, may be broken up, or fragmented into, a plurality of segments. Various methods of fragmenting nucleic acids are well known in the art. These methods may be, for example, either chemical or physical in nature. Chemical fragmentation may include partial degradation with a DNAse; partial depurination with acid; the use of restriction enzymes; intron-encoded endonucleases; DNA-based cleavage methods, such as triplex and hybrid formation methods, that rely on the specific hybridization of a nucleic acid segment to localize a cleavage agent to a specific location in the nucleic acid molecule; or other enzymes or compounds which cleave DNA at known or unknown locations. Physical fragmentation methods may involve subjecting the DNA to a high shear rate. High shear rates may be produced, for example, by moving DNA through a chamber or channel with pits or spikes, or forcing the DNA sample through a restricted size flow passage, e.g., an aperture having a cross sectional dimension in the micron or submicron scale. Other physical methods include sonication and nebulization. Combinations of physical and chemical fragmentation methods may likewise be employed such as fragmentation by heat and ion-mediated hydrolysis. See for example, Sambrook et al., “Molecular Cloning: A Laboratory Manual,” 3rd Ed. Cold Spring Harbor Laboratory Press, Cold Spring Harbor, N.Y. (2001) (“Sambrook et al.”) which is incorporated herein by reference in its entirety for all purposes. These methods may be optimized to digest a nucleic acid into fragments of a selected size range. Useful size ranges may be from 20, 50, 100, 200, or 400 base pairs.

It is advantageous to use probes which bind to the 3′ regions of transcripts specifically where the patient tissue to be analyzed for gene expression is RNA extracted from paraffin embedded tissue. Each probe will be capable of hybridizing to a complementary sequence in the respective transcript which occurs within 500 bp, 400 bp, 300 bp, or 200 bp, or 100 bp of the 3′ end of the transcript.

Contrary to conventional methods, in order to design an array with 60,000 transcripts on it, using the present methods, one of ordinary skill would not access 60,000 accession numbers or Gene IDs and design probes from those sequence, but would actually derive 60,000 transcripts from tissue samples. The use of 3′ sequencing to generate these sequences, i.e. the “input sequence set” or design sequences, is particularly relevant.

As used herein the term “input sequence set” or “design sequence” is defined as the sequences that are used in the design of the microarray.

In a first embodiment, the invention provides a method for designing a nucleic acid microarray by isolating RNA from tissue samples, sequencing transcripts in the isolated RNA and designing nucleic acid probes directed to the extreme 3′ end of the sequenced transcript on a microarray. The probes preferably bind to the extreme 3′ end of the transcript to account for any alternative polyadenylation sites specific to the tissue or disease state from which the RNA is isolated. Probes are preferably complementary to the extreme 3′ end of the transcript and bind specifically under stringent hybridization conditions.

RNA extraction methods are known in the art and commercial RNA exctraction kits such as RNeasy (Qiagen Corporation, Valencia, Calif.), ArrayIt® micro total RNA extraction kit (Telechem International, Sunnyvale, Calif.) and ToTALLY RNA™ (Ambion, Foster City, Calif.) may also be used to isolate RNA from a tissue sample. (Sambrook et al). Methods to prepare a cDNA library are also known in the art and include methods of reverse transcription, cloning and plating. (Sambrook et al.). Primers that are directed to the extreme 3′ end of the transcript are particularly useful for ensuring that the extreme 3′ end of the sequence is accurately reverse transcribed from the isolated RNA. For example, anchored oligo dT primers, or oligo dT primers are particularly useful for ensuring that the extreme 3′ end of the transcript is accurately transcribed for library generation.

The oligonucleotides used as primer in the sequencing reaction may also contain labels. These labels comprise but are not limited to radionucleotides, fluorescent labels, biotin, chemiluminescent labels. Different sequencing technologies known in the art, for instance dideoxysequencing, cycle sequencing, minisequencing, sequencing by hybridization, MS-based sequencing, DNA sequencing by synthesis (SBS) approaches such as pyrosequencing, sequencing of single DNA molecules, polymerase colonies and any variants thereof may be useful for sequencing the extreme 3′ end of the transcript.

In one embodiment, high throughput 3′ sequencing may be used to generate the design sequences for the array. The input sequence set is derived by high throughput sequencing of all or substantially all of the transcripts in a specific tissue or disease state. The use of a high throughput sequencing approach, makes it possible to generate probes closer to the 3′ end of the transcripts than are contained on other generic microarrays.

After deriving the design sequences, probes or probe sets are designed to specifically bind to the extreme 3′ end of the transcript in a target sample. Commercially available software exists to design probes and probe sets from a given sequence optimized to reduce cross-hybridization between oligonucleotides and targets. Examples of such software programs include, but are not limited to, Visual OMP, Oligo Wiz 2.0 and ArrayDesigner.

Polynucleotide sequences derived using the 3′ sequencing methods described herein may be used in the design and construction of the nucleotide arrays. A set of probes corresponding to the extreme 3′ end of a transcript may be selected after the sequence is obtained. One of most important factors considered in probe design include probe length, melting temperature (Tm), and GC content, specificity, complementary probe sequences, and 3′-end sequence. In one embodiment, optimal probes are generally 17-30 bases in length, and contain about 20-80%, such as, for example, about 50-60% G+C bases. Tm's between 50° C. and 80° C., e.g. about 50° C. to 70° C. are typically preferred.

After probes and probe sets are designed, microarrays comprising these probes are fabricated that are specifically designed for binding to RNA in a tissue or disease state. Microarrays may be fabricated using a variety of technologies, including printing with fine-pointed pins onto glass slides, photolithography using pre-made masks, photolithography using dynamic micromirror devices, ink-jet printing, or electrochemistry on microelectrode arrays. Long Oligonucleotide Arrays are composed of 60-mers, or 50-mers and are produced by ink-jet printing on a silica substrate (Agilent). Short Oligonucleotide Arrays are composed of 25-mer or 30-mer and are produced by photolithographic synthesis (Affymetrix) on a silica substrate or piezoelectric deposition (Applied Microarrays) on an acrylamide matrix. Another method, Maskless Array Synthesis (using micromirrors) from NimbleGen Systems has combined flexibility with large numbers of probes.

Particularly, the combination of relevant disease-specific content and 3′ based probe design provides unique methods and products capable of robust profiling RNA from both fresh frozen and FFPE tissue.

These methods may also be used to generate arrays representative of substantially all of a transcriptome from a tissue. For example, in one embodiment, when defining the Lung cancer transcriptome, a 3′-based sequencing approach is employed facilitating design of probesets to the 3′ extremity of each transcript. This approach ensures much higher detection rate and is thus optimally designed to detect RNA transcripts from both fresh frozen and FFPE tissue samples. The Almac Diagnostics Lung Cancer DSA™ is an example of a research tool that is capable of producing biologically meaningful and reproducible data from RNA extracted from FFPE tissue.

### II Microarrays

To create improved microarrays, nucleic acid probes designed to hybridize to the extreme 3′ end of the transcript are arranged on a solid support to produce an array. The arrays may represent a plurality of tissue transcripts corresponding to one or more tissues or one or more diseases. Disease-specific arrays contain transcripts that are expressed in one given disease setting. The arrays provided herein for use in diagnostic, prognostic and predictive assays are constructed using suitable techniques known in the art. See, for example, U.S. Pat. Nos. 5,486,452; 5,830,645; 5,807,552; 5,800,992 and 5,445,934. In each array, individual nucleic acid probes may be presented only once or may be presented multiple times. The arrays may optionally also include control nucleic acid probes directed to housekeeping genes for example in the case of positive controls, or genes known not expressed in the tissue as negative controls.

In one embodiment, tissue-specific nucleic acid probes representative of the transcripts and/or transcript fragments are immobilized on an array at a plurality of physically distinct locations using nucleic acid immobilization or binding techniques well known in the art. The fragments at several physically distinct locations may together compose an entire transcript or discreet portions of the entire transcript. The fragments may be complementary to contiguous portions of a transcript or discontiguous portions of a transcript. Hybridization of a nucleic acid molecule from a target sample to the fragments on the array is indicative of the presence of the target transcript in the sample. Hybridization and detection of hybridization are performed by routine detection methods well known to those skilled in the art and described in more detail below.

In one embodiment, multiple probe sequences are used that distinguish a target sequence from other nucleic acid sequences in the diseased tissue sample. In some embodiments, at least 2% of a design sequence is represented by the combination of probes on an array. In further embodiments, at least 5%, at least 10%, at least 20%, at least 30%, at least 40%, at least 50%, at least 60%, at least 70%, at least 80%, or at least 90% of a target sequence is represented by probes on an array.

In one embodiment, the transcripts are complementary to at least 50% of the probe sequence. In other embodiments, the transcripts are complementary to at least 60%, 70%, 80%, 90% or 100% of the probe sequence.

In another embodiment, a nucleic acid probe corresponding to the whole extreme 3′ end of the transcript or fragment of a whole extreme 3′ end of the transcript is immobilized on an array at only one physically distinct location in a “spotted array” format. Multiple copies of the specific nucleic acid probes may be bound to the array substrate at the discreet location. Preferably, this type of “spotted array” includes one or more of the nucleic acid molecules newly identified herein.

For a given array, each nucleic acid probe may be a whole sequence or a sequence fragmented into different lengths. It is not necessary that all fragments constituting a whole transcript be present on the array. Hybridization of a transcript to probes on an array that represent a portion of the total transcript may be indicative of the presence or expression level of the transcript in the tissue from which it was isolated.

One of skill in the art will appreciate that nucleic acid probes on a given array are complementary to the transcript-specific targets in a given tissue sample. Arrays containing the native sequences may also be designed to identify the presence of antisense molecules in a target sample. Endogenous antisense RNA transcripts are of interest because recent literature has implicated endogenous antisense in cancer and other diseases.

As mentioned above, arrays specific for certain diseases, such as a specific cancer, may be designed to contain probes directed to specific polyadenylation sites.

Any suitable substrate may be used as the solid phase to which the nucleic acid probes are immobilized or bound. For example, the substrate may be glass, plastics, metal, a metal-coated substrate or a filter of any material. The substrate surface may be of any suitable configuration. For example the surface may be planar or may have ridges or grooves to separate the nucleic acid probes immobilized on the substrate. In an alternative embodiment, the nucleic acids are attached to beads, which are separately identifiable. The nucleic acid probes are attached to the substrate in any suitable manner that makes them available for hybridization, including covalent or non-covalent binding.

### III. Methods of Using the Arrays

The arrays described herein may be used for any suitable purpose, such as, but not limited to, expression profiling, diagnosis, prognosis, drug therapy, drug screening, and the like.

Generally, RNA is isolated from a tissue sample and contacted with the array and allowed to hybridize under sufficient stringency to permit specific binding between the target sequences from the tissue sample and the complementary probes on the microarray. The probes immobilized on the substrate are suitable for hybridization under stringent conditions to transcripts from a nucleic acid sample. Fluorescently labeled nucleotide probes may be generated through incorporation of fluorescent nucleotides by reverse transcription of RNA extracted from tissues of interest. Labeled probes applied to the array hybridize with specificity to each nucleotide on the array. After stringent washing to remove non-specifically bound probes, the array is scanned by confocal laser microscopy or by another detection method, such as, for example, a CCD camera. Quantitation of hybridization of each arrayed element allows for assessment of corresponding transcript abundance.

The term “substantially” identical or homologous or similar varies with the context as understood by those skilled in the relevant art and generally means at least 70%, preferably means at least 80%, more preferably at least 90%, and most preferably at least 95% identity.

“Stringency” of hybridization reactions is readily determinable by one of ordinary skill in the art, and generally is an empirical calculation dependent upon probe length, washing temperature, and salt concentration. In general, longer probes require higher temperatures for proper annealing, while shorter probes need lower temperatures. Hybridization generally depends on the ability of denatured DNA to re-anneal when complementary strands are present in an environment below their melting temperature. The higher the degree of desired homology between the probe and hybridizable sequence, the higher the relative temperature which may be used. As a result, it follows that higher relative temperatures would tend to make the reaction conditions more stringent, while lower temperatures less so. For additional details and explanation of stringency of hybridization reactions, see Ausubel et al., Current Protocols in Molecular Biology, Wiley Interscience Publishers, (1995).

“Stringent conditions” or “high stringency conditions”, as defined herein, typically: (1) employ low ionic strength and high temperature for washing, for example 0.015 M sodium chloride/0.0015 M sodium citrate/0.1% sodium dodecyl sulfate at 50.degree. C.; (2) employ during hybridization a denaturing agent, such as formamide, for example, 50% (v/v) formamide with 0.1% bovine serum albumin/0.1% Ficoll/0.1% polyvinylpyrrolidone/50 mM sodium phosphate buffer at pH 6.5 with 750 mM sodium chloride, 75 mM sodium citrate at 42° C.; or (3) employ 50% formamide, 5×SSC (0.75 M NaCl, 0.075 M sodium citrate), 50 mM sodium phosphate (pH 6.8), 0.1% sodium pyrophosphate, 5.times. Denhardt's solution, sonicated salmon sperm DNA (50 μg/ml), 0.1% SDS, and 10% dextran sulfate at 42° C., with washes at 42° C. in 0.2×SSC (sodium chloride/sodium citrate) and 50% formamide at 55° C., followed by a high-stringency wash consisting of 0.1×SSC containing EDTA at 55° C.

“Moderately stringent conditions” may be identified as described by Sambrook et al., Molecular Cloning: A Laboratory Manual, New York: Cold Spring Harbor Press, 1989, and include the use of washing solution and hybridization conditions (e.g., temperature, ionic strength and % SDS) less stringent that those described above. An example of moderately stringent conditions is overnight incubation at 37° C. in a solution comprising: 20% formamide, 5×SSC (150 mM NaCl, 15 mM trisodium citrate), 50 mM sodium phosphate (pH 7.6), 5× Denhardt's solution, 10% dextran sulfate, and 20 mg/ml denatured sheared salmon sperm DNA, followed by washing the filters in 1×SSC at about 37-50° C. The skilled artisan will recognize how to adjust the temperature, ionic strength, etc. as necessary to accommodate factors such as probe length and the like.

The present microarrays are useful for the study of different disease states. The term “disease” or “disease state” includes all diseases which result or could potentially cause a change of the small molecule profile of a cell, cellular compartment, or organelle in an organism afflicted with the disease. Such diseases may be grouped into three main categories: neoplastic disease, inflammatory disease, and degenerative disease.

Examples of diseases include, but are not limited to, metabolic diseases (e.g., obesity, cachexia, diabetes, anorexia, etc.), cardiovascular diseases (e.g., atherosclerosis, ischemia/reperfusion, hypertension, myocardial infarction, restenosis, cardiomyopathies, arterial inflammation, etc.), immunological disorders (e.g., chronic inflammatory diseases and disorders, such as Crohn's disease, inflammatory bowel disease, reactive arthritis, rheumatoid arthritis, osteoarthritis, including Lyme disease, insulin-dependent diabetes, organ-specific autoimmunity, including multiple sclerosis, Hashimoto's thyroiditis and Grave's disease, contact dermatitis, psoriasis, graft rejection, graft versus host disease, sarcoidosis, atopic conditions, such as asthma and allergy, including allergic rhinitis, gastrointestinal allergies, including food allergies, eosinophilia, conjunctivitis, glomerular nephritis, certain pathogen susceptibilities such as helminthic (e.g., leishmaniasis) and certain viral infections, including HIV, and bacterial infections, including tuberculosis and lepromatous leprosy, etc.), myopathies (e.g. polymyositis, muscular dystrophy, central core disease, centronuclear (myotubular) myopathy, myotonia congenita, nemaline myopathy, paramyotonia congenita, periodic paralysis, mitochondrial myopathies, etc.), nervous system disorders (e.g., neuropathies, Alzheimer's disease, Parkinson's disease, Huntington's disease, amyotropic lateral sclerosis, motor neuron disease, traumatic nerve injury, multiple sclerosis, acute disseminated encephalomyelitis, acute necrotizing hemorrhagic leukoencephalitis, dysmyelination disease, mitochondrial disease, migrainous disorder, bacterial infection, fungal infection, stroke, aging, dementia, peripheral nervous system diseases and mental disorders such as depression and schizophrenia, etc.), oncological disorders (e.g., leukemia, brain cancer, prostate cancer, liver cancer, ovarian cancer, stomach cancer, colorectal cancer, throat cancer, breast cancer, skin cancer, melanoma, lung cancer, sarcoma, cervical cancer, testicular cancer, bladder cancer, endocrine cancer, endometrial cancer, esophageal cancer, glioma, lymphoma, neuroblastoma, osteosarcoma, pancreatic cancer, pituitary cancer, renal cancer, and the like) and ophthalmic diseases (e.g. retinitis pigmentosum and macular degeneration). The term also includes disorders, which result from oxidative stress, inherited cancer syndromes, and metabolic diseases known and unknown.

Further details of the invention will be described in the following non-limiting Example.

### EXAMPLE 1

### Using High-Throughput 3′-Sequencing to Identify Microarray Design Sequences

Library Generation and cDNA Sequencing
RNA Extraction from Tissue

RNA was isolated from frozen lung tissue chunks using RNA STAT-60 in accordance with manufacturers instructions. Modifications to manufacturers instructions included the homogenization of each tissue chunk in RNA-STAT-60 at 20 Hz for 6 mins using the Tissue Lyser (Qiagen) prior to commencement of extraction. The Biophotometer (Eppendorf) was used to determine RNA yield, and RNA quality was checked using the Agilent 2100 Bioanalyzer with the RNA Nano LabChip kit (Agilent Technologies; Palo Alto, Calif.). Equal quantities of good quality RNAs (RNAs with well defined 28S and 18S ribosomal peaks) were pooled for mRNA isolation.

mRNA Isolation from Total RNA

mRNA was isolated from pooled lung total RNA using the μMACS mRNA isolation kit (Miltenyi Biotec) according to manufacturers instructions. MRNA was isolated from 538 μg of pooled total lung RNA and eluted in 12 μl of nuclease free water. The Biophotometer (Eppendorf) was used to determine mRNA yield. mRNA quality was checked using the Agilent 2100 Bioanalyzer with the RNA Nano LabChip kit (Agilent Technologies; Palo Alto, Calif.). The mRNA Nano assay was used to determine percentage ribosomal contamination.

Construction of Lung cDNA Library

Construction of lung cDNA library was performed using the CloneMiner™ cDNA library construction kit (Invitrogen). Construction of a non-radiolabeled cDNA library was performed according to manufacturers instructions. 3 μg of lung mRNA previously isolated was used to generate the library. cDNA inserts were recombined into pDONR™ 222 vector and electroporated into DH10B™ T1 Phage resistant cells (Invitrogen). 1 μl of recombined pDONR™ 222 vector was added to 40 μl of electrocompetent cells. Entire contents of tube was transferred to a pre-chilled 1 mm gap width cuvette and inserted into the Electroporator 2510 (Eppendorf) using the following settings 1660V with time constant (τ) 5 ms. After electroporation 1 ml of SOC medium (Invitrogen) was added to the cells and transferred to a 15 ml tube and shaken for 1 hour at 37° C. in the Innova 4300 incubater shaker (New Brunswick Scientific) at 225 rpm. Then an equal volume of sterile freezing media (60% SOC medium (Invitrogen), 40% Glycerol (Sigma)) was added to the samples prior to aliquotting into multiple tubes and storage at −80° C. Titre determination was performed on 3 pre-warmed LB plates containing 50 μg/ml of kanamycin (Sigma). Each plate was spread with 1 μl, 5 μl or 10 μl of the transformed cells and incubated overnight at 37° C. in the BD115 incubator (Binder). Number of colonies on each plate was counted to determine average titre of library. The total colony forming units (cfu) was determined by multiplying the average titre by the total volume

Qualifying the cDNA Library.

Qualifying of the cDNA library was performed by digesting 24 positive transformants with BsrG 1. 12 μl of plasmid DNA was incubated for 16 hrs at 37° C. with 3.0 μl of NE 2, 0.3 μl of BSA, 0.1 μl of BsrG 1 and 14 μl of nuclease free water. Digested samples were then analysed on the Agilent 2100 Bioanalyzer using the DNA 7500 assay protocol. The pDONR™ 222 vector without insert should show a digestion pattern of the following lengths 2.5 kb, 1.4 kb and 790 bp and each cDNA entry clone should have a vector backbone band of 2.5 kb and additional insert bands. Individual digested band sizes for each clone were added together to get the total insert length. Average insert size length and percentage transformants was then calculated for the 24 transformants.

Bacterial lawns of the individual cDNA libraries were plated out onto bioassay trays, QTrays (Genetix) at a density of approximately 2000 cfu per tray. Individual colonies were picked using the QPix 2^{XT} colony picker and grown in CircleGrow media (MP Biomedicals LLC) overnight at 37° C. with shaking.

Plasmid preparation was performed using a modified Montáge® alkaline lysis method (Millipore). The method employed MultiScreen® Plasmid384 Miniprep clearing plates for centrifugal lysate clearing instead of vacuum filtration. All the liquid handling steps were carried out on Biomek NX workstations (Beckman Coulter).

384-well sequence reaction plates were set-up containing approximately 100 ng template DNA, 5 μM primer (either universal M13_reverse, anchored oligo dT or oligo dT,), Big Dye Terminator v.3.1 (Applied Biosystems Inc.) and Sequencing Buffer (Applied Biosystems Inc). Cycle sequencing conditions were 40 cycles, 95° C. 10 sec, 50° C. 5 sec, 60° C. 2 min 30 sec. Sequence reactions were cleaned up using CleanSEQ (Agencourt Biosciences) on Biomek NX liquid handlers. Sequence plates were analysed on Appled Biosystems 3730/3730x1 DNA Analysers using Applied Biosystems Sequence Analysis software.

### EXAMPLE 2

### Identifying a Lung Cancer Disease-Specific Transcriptome

The transcript information used to design the Lung Cancer disease specific array (DSA™) research tool was generated by a high throughput 3′-based sequencing approach to define the Lung cancer transcriptome. Probes were generated at the 3′ end of each identified transcript and the Lung cancer DSA research tool was custom designed by Affymetrix (Affymterix Corporation, Santa Clara, Calif.). This combination of relevant disease specific content and 3′ based probe design allows robust profiling from Formalin Fixed Paraffin Embedded (FFPE) derived RNA.

While the present invention has been described with reference to what are considered to be the specific embodiments, it is to be understood that the invention is not limited to such embodiments. To the contrary, the invention is intended to cover various modifications and equivalents included within the spirit and scope of the appended claims.

We claim:

1. A method of designing a nucleic acid microarray comprising:
isolating RNA from a tissue sample;
sequencing transcripts in the tissue sample from the 3′ end of the transcripts until substantially all of the transcripts are sequenced to derive extreme 3′ sequences of the transcripts;
using the sequences to design probes for the microarray; and
producing a microarray possessing the probes directed to the extreme 3′ end of transcripts in a tissue sample.

2. The method of claim 1 wherein the extreme 3′ end of the transcript comprises the most 3′ 300 base pairs of the transcript.

3. The method of claim 1 wherein the extreme 3′ end of the transcript comprises the most 3′ 400 base pairs of the transcript.

4. The method of claim 1 wherein the extreme 3′ end of the transcript comprises the most 3′ 500 base pairs of the transcript.

5. The method of claim 1 wherein the extreme 3′ end of the transcript comprises the most 3′ 200 base pairs of the transcript.

6. The method of claim 1 wherein the extreme 3′ end of the transcript comprises the most 3′ 100 base pairs of the transcript.

7. A tissue-specific or disease-specific microarray comprising probes directed to the extreme 3′ end of a transcript.

8. The microarray of claim 7 wherein the probes are directed to polyadenylation sites specific to a particular tissue or diseases state.

9. The microarray of claim 7 wherein the extreme 3′ end of the transcript comprises the most 3′ 300 base pairs of the transcript.

10. The microarray of claim 7 wherein the extreme 3′ end of the transcript comprises the most 3′ 400 base pairs of the transcript.

11. The microarray of claim 7 wherein the extreme 3′ end of the transcript comprises the most 3′ 500 base pairs of the transcript.

12. The microarray of claim 7 wherein the extreme 3′ end of the transcript comprises the most 3′ 200 base pairs of the transcript.

13. The microarray of claim 7 wherein the extreme 3′ end of the transcript comprises the most 3′ 100 base pairs of the transcript.

14. A method of using the microarray of claim 7 to profile expression in a tissue comprising:
contacting a nucleic acid sample derived from a tissue with the array under conditions where nucleic acid targets in the sample hybridize specifically to probes on the array;
washing unbound nucleic acid targets off the microarray; and
detecting bound target to the microarray
wherein presence of bound target to the microarray is indicative of gene expression in the tissue.

15. The method of claim 14 wherein the tissue comprises a diseased tissue

16. The method of claim 14 wherein the diseased tissue is a cancer tissue.

17. The method of claim 14 wherein the cancer is selected from leukemia, brain cancer, prostate cancer, liver cancer, ovarian cancer, stomach cancer, colorectal cancer, throat cancer, breast cancer, skin cancer, melanoma, lung cancer, sarcoma, cervical cancer, testicular cancer, bladder cancer, endocrine cancer, endometrial cancer, esophageal cancer, glioma, lymphoma, neuroblastoma, osteosarcoma, pancreatic cancer, pituitary cancer, or renal cancer.
